(19) United States
(12) Patent Application Publication
(10) Pub. No.: US 2020/0020003 A1
(43) Pub. Date: Jan. 16, 2020

(54) COMPONENT ORDERING MODE SELECTION DEVICE, COMPONENT ORDERING MODE SELECTION METHOD, AND PROGRAM

(71) Applicant: HITACHI, LTD., Tokyo (JP)

(72) Inventors: Masataka TANAKA, Tokyo (JP); Toshihiro MORISAWA, Tokyo (JP); Hiroyuki YANAHIRA, Tokyo (JP); Hiroyuki SEYA, Tokyo (JP)

(21) Appl. No.: 16/335,286

(22) PCT Filed: Sep. 26, 2017
(86) PCT No.: PCT/JP2017/034626

§ 371 Date: Mar. 21, 2019

(30) Foreign Application Priority Data
Oct. 12, 2016 (JP) 2016-200626

(51) Int. Cl. G06Q 30/06; G06Q 10/08

(52) U.S. Cl. CPC G06Q 30/0601; G06Q 10/087

(57) ABSTRACT

The disclosure can evaluate a relation between a procurement cost and an inventory value of a component on the basis of a future manufacturing plan, and select a more appropriate ordering mode. A device includes: a product design allocation unit configured to allocate a predetermined design pattern to a product constituent element at a predetermined application rate which is based on a future design plan; a procurement cost computation unit configured to compute, for each ordering mode, a procurement cost of a component which is used in the product constituent element; an inventory value computation unit configured to compute, for each ordering mode, an inventory value of the component; and an ordering mode evaluation unit configured to evaluate a ratio of the procurement cost and the inventory value.

### TECHNICAL FIELD

The present invention relates to a component ordering mode selection device, a component ordering mode selection method, and a program. The present invention claims priority based on Japanese patent application No. 2016-200626, filed on Oct. 12, 2016, and the contents described in the application are incorporated in the present application by reference for the designated states where incorporation of documents by reference is allowed.

### BACKGROUND ART

PTL 1 relates to a multi-kinds small-quantity manufacturing method and describes that the method “includes the steps of: dividing ordered products into standard units and customized units; adding manufacturing management numbers corresponding to order codes indicating the accepted orders to the standard units and the customized units; allocating the inventory or arranging a purchase for the standard units; designing and manufacturing the customized units after individual orders are placed; and assembling the product with the order code by using produced customized units with the manufacturing management numbers and the allocated or purchased standard units with the manufacturing management numbers”.

### CITATION LIST

### Patent Literature

PTL 1: JP 2003-58225A

### SUMMARY OF INVENTION

### Technical Problem

In the method described in PTL 1, a method of dividing products into standard units and customized units, and allocating inventory items and performing component design and arrangement after receiving an individual order for each unit is described. However, in the method of PLT 1, it is difficult to determine whether to have an inventory or to design and arrange a component individually, and then to place an order for an appropriate component, for individual order design products where the application propriety of the standard unit changes depending on customer requirement specifications. In the method of PLT 1, in a case of gradually switching old and new standard units by design improvement, it is difficult to determine until when a component inventory for the standard units of old designs may be kept.

The present invention is provided in view of the problem above, and has an object to provide a component ordering mode selection device which can evaluate, on the basis of a future manufacturing plan, a relation between a procurement cost and an inventory value of a component, and select a more appropriate ordering mode.

### Solution to Problem

To solve the above-described problems, a component ordering mode selection device according to the present invention includes: a product design allocation unit configured to allocate a predetermined design pattern to a product constituent element at a predetermined application rate based on a future design plan; a procurement cost computation unit configured to compute, for each ordering mode, a procurement cost of a component to be used in the product constituent element; an inventory value computation unit configured to compute, for each ordering mode, an inventory value of the component; and an ordering mode evaluation unit configured to evaluate a ratio of the procurement cost and the inventory value.

### Advantageous Effects of Invention

The component ordering mode selection device according to the present invention can evaluate, on the basis of a future manufacturing plan, a relation between a procurement cost and an inventory value of a component, and select a more appropriate ordering mode.

Note that problems, configurations, and effects other than those described above will be clarified by the following description of the embodiment.

### BRIEF DESCRIPTION OF DRAWINGS

FIG. 1 is a functional block diagram illustrating an example of a function configuration of a component ordering mode selection device.

FIG. 2 is a diagram illustrating an example of manufacturing plan information.

FIG. 3 is a diagram illustrating an example of product configuration information.

FIG. 4 is a diagram illustrating an example of design pattern information.

FIG. 5 is a diagram illustrating an example of design drawing information.

FIG. 6 is a diagram illustrating an example of component ordering information.

FIG. 7 is a diagram illustrating an example of a hardware configuration of the component ordering mode selection device.

FIG. 8 is a diagram illustrating an example of an instruction input screen to accept an execution instruction of component ordering mode selection processing.

FIG. 9 is a flowchart illustrating an example of the component ordering mode selection processing.

FIG. 10 is a diagram illustrating an example of product design allocation information.

FIG. 11 is a diagram illustrating an example of component ordering time determination information.

FIG. 12 is a diagram illustrating an example of procurement cost transition information.

FIG. 13 is a diagram illustrating an example of component inventory transition information.

FIG. 14 is a diagram illustrating an example of evaluation information per ordering.

FIG. 15 is a screen example illustrating an evaluation result per ordering and inventory transition per component.

### DESCRIPTION OF EMBODIMENTS

One embodiment of the present invention will be described with reference to the drawings as follows.

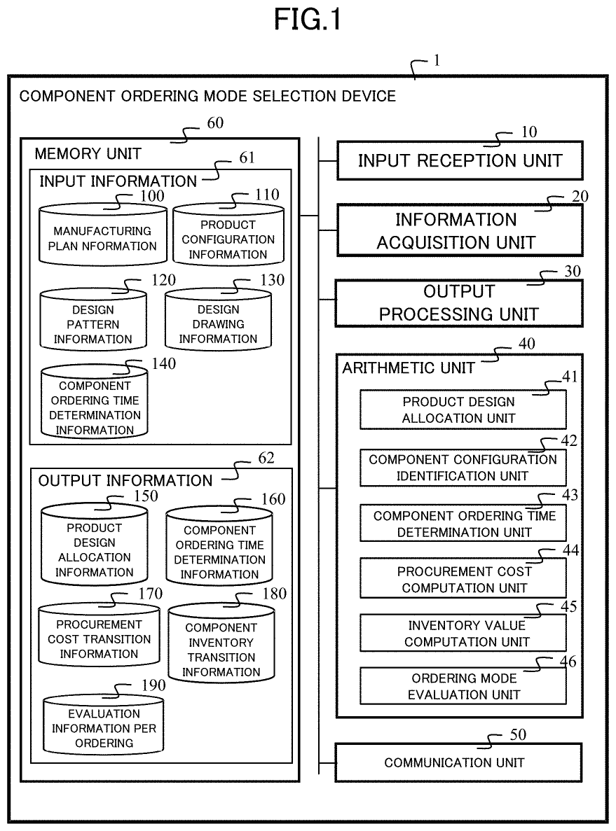

FIG. 1 is a functional block diagram illustrating an example of a function configuration of a component ordering mode selection device 1. The component ordering mode selection device 1 includes an input reception unit 10, an information acquisition unit 20, an output processing unit 30, an arithmetic unit 40, a communication unit 50 and a memory unit 60.

The input reception unit 10 is a function unit accepting inputs of various kinds of information from an input device included in the component ordering mode selection device 1 or an external device connected through the communication unit 50. For example, the input reception unit 10 accepts inputs of information such as a target period of the component ordering mode selection processing or an execution instruction of processing from the input device, such as a keyboard, a mouse, or a touch panel, or the external device. The input reception unit 10 delivers accepted information to a corresponding predetermined function unit.

The information acquisition unit 20 is a function unit acquiring predetermined input information. Specifically, when the component ordering mode selection processing is started, the information acquisition unit 20 acquires input information stored in the memory unit 60 and delivers the input information to a predetermined function unit. Note that details of input information are described later.

The output processing unit 30 generates screen information to be displayed on an output device included in the component ordering mode selection device 1 or an external device. Specifically, the output processing unit 30 generates the screen information indicating an evaluation result and an inventory transition by using output information generated by the arithmetic unit 40, and outputs the evaluation result and the inventory transition to an output device to display.

The arithmetic unit 40 includes a product design allocation unit 41, a component configuration identification unit 42, a component ordering time determination unit 43, a procurement cost computation unit 44, an inventory value computation unit 45, and an ordering mode evaluation unit 46.

The product design allocation unit 41 is a function unit allocating a predetermined design pattern to a constituent element of a product (e.g., a unit constituting a product). Specifically, the product design allocation unit 41 allocates a predetermined design pattern to each unit of the product at a predetermined application rate, by using predetermined input information (e.g., manufacturing plan information, product configuration information, design pattern information, and design drawing information), based on a future manufacturing plan.

The component configuration identification unit 42 is a function unit identifying a type of a component used in a design pattern allocated to a unit. Specifically, the component configuration identification unit 42 identifies a type of a component by using predetermined information (e.g., product design allocation information and design drawing information). The component configuration identification unit 42 computes an ordering quantity and an ordering value of a component.

The component ordering time determination unit 43 is a function unit determining an ordering time of a component or the like. Specifically, the component ordering time determination unit 43 determines an ordering time of a component or the like by using predetermined information (e.g., product design allocation information and component ordering information).

The procurement cost computation unit 44 is a function unit computing a procurement cost of a component. Specifically, the procurement cost computation unit 44 computes a procurement cost based on an ordering value per component and per ordering mode, by using predetermined information (e.g., procurement cost transition information).

The inventory value computation unit 45 is a function unit computing an inventory value of a component. Specifically, the inventory value computation unit 45 computes an inventory value per component and per ordering mode by using predetermined information (e.g., component inventory transition information).

The ordering mode evaluation unit 46 is a function unit evaluating a procurement cost and an inventory value of a component. Specifically, the ordering mode evaluation unit 46 evaluates a relation between the procurement cost and the inventory value for each component by performing a predetermined operation using the procurement cost and the inventory value.

The memory unit 60 is a function unit storing various kinds of information. The memory unit 60 stores input information 61 and output information 62. Specifically, the memory unit 60 stores in advance manufacturing plan information 100, product configuration information 110, design pattern information 120, design drawing information 130, and component ordering information 140 as the input information 61. Note that these information items are used for component ordering mode selection processing to be described later.

The memory unit 60 stores product design allocation information 150, component ordering time determination information 160, procurement cost transition information 170, component inventory transition information 180, and evaluation information per ordering 190 as the output information 62. Details of the output information 62 will be described later.

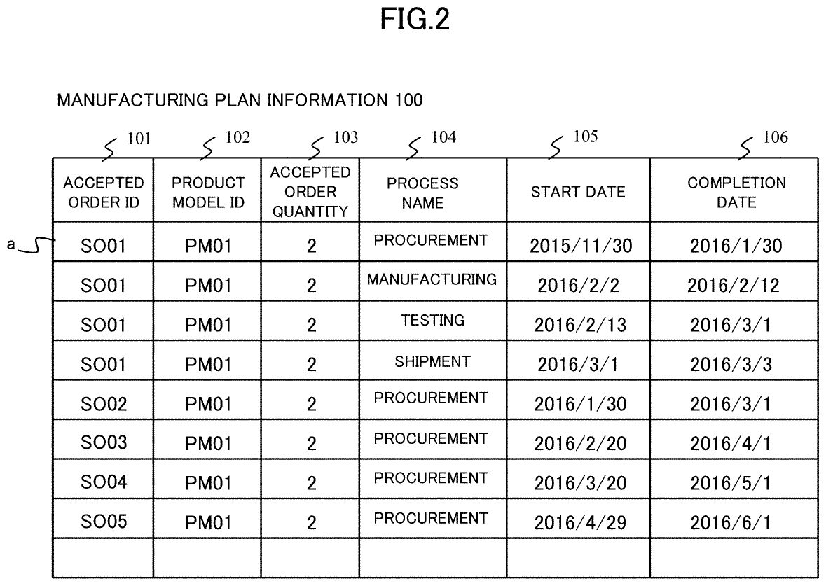

FIG. 2 is a drawing illustrating an example of the manufacturing plan information 100. The manufacturing plan information 100 is information for managing a future manufacturing plan of a product. Specifically, the manufacturing plan information 100 includes a record in which an accepted order ID 101, a product model ID 102, an accepted order quantity 103, a process name 104, a start date 105, and a completion date 106 are associated with one another.

The accepted order ID 101 is information for identifying each accepted order. The product model ID 102 is information for identifying a model of an ordered product. The accepted order quantity 103 is information for indicating a manufacturing quantity of the ordered product. The process name 104 is information for identifying a name indicating a manufacturing process of the ordered product. Examples of the process name 104 includes procurement, manufacturing, testing, and shipment. The start date 105 is information indicating a date to start an operation of the associated process name 104. The completion date 106 is information indicating a date to complete the operation of the associated process name 104.

For example, a record a of FIG. 2 indicates a plan of, for the accepted order of accepted order ID “SO01” for “two” products of the product model ID “PM01”, starting a “procurement” process from “Nov. 11, 2015”, and completing by “Jan. 30, 2016”.

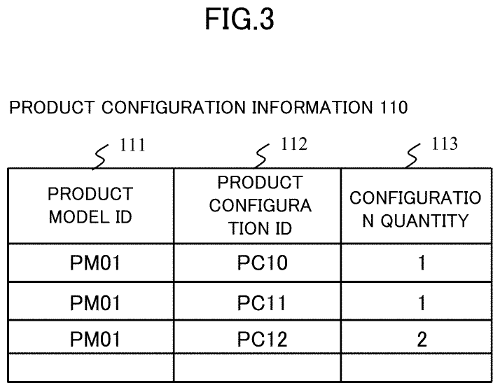

FIG. 3 is a diagram illustrating an example of the product configuration information 110. The product configuration information 110 is information for managing constituent elements, such as units, of a product. Specifically, the product configuration information 110 includes a record in which a product model ID 111, a product configuration ID 112, and a configuration quantity 113 are associated with one another.

The product model ID 111 is information for identifying a model of a product, and is information that is common to the product model ID 102 of the manufacturing plan information 100. The product configuration ID 112 is information for identifying a constituent element, such as a unit, constituting the product. The configuration quantity 113 is information for indicating a quantity of constituent elements included in the product.

For example, the product configuration information 110 of FIG. 3 indicates that the product of the product model ID “PM01” includes “one” unit of the product configuration ID “PC10,” “one” unit of the product configuration ID “PC11,” and “two” units of the product configuration ID “PC12”.

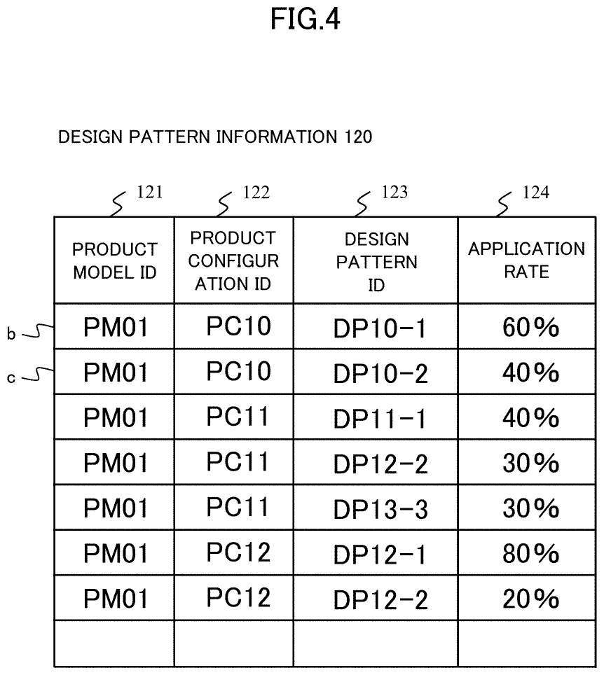

FIG. 4 is a diagram illustrating an example of the design pattern information 120. The design pattern information 120 is information for managing a design pattern or the like applied to a constituent element, such as a unit, constituting a product. Specifically, the design pattern information 120 includes a record in which a product model ID 121, a product configuration ID 122, a design pattern ID 123, and an application rate 124 are associated with one another.

The product model ID 121 is information for identifying a model of a product, and is information that is common to the product model ID 102 of the manufacturing plan information 100. The product configuration ID 122 is information for identifying a constituent element, such as a unit, constituting a product, and is information that is common to the product configuration ID 112 of the product configuration information 110.

The design pattern ID 123 is information for identifying a design pattern applied to a constituent element, such as a unit, constituting a product. For example, as illustrated in records b and c of FIG. 4, a plurality of design patterns may be associated with the same unit. The difference in these design patterns depends on, for example, the difference in a module type used for a unit, or the difference between a design pattern applied to an old type product and a design pattern applied to a new type product.

The application rate 124 is information for indicating an application rate of a design pattern applied to a unit. The application rate 124, for example, may be configured based on a ratio deduced from a past order rate of a module type applied to a product, or may be configured based on a future manufacturing plan or based on a manufacturing proportion of an old type product and a new type product.

For example, the records b and c of FIG. 4 indicate that there are two design patterns “DP10-1” and “DP10-2” to be applied to a unit with the product model ID “PM01” and the product configuration ID “PC10”, and application rates of respective design patters are “60%” and “40%”.

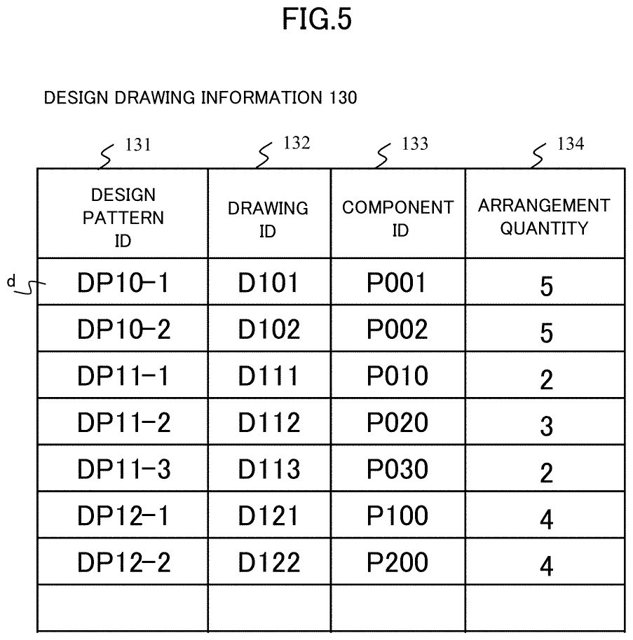

FIG. 5 is a diagram illustrating an example of the design drawing information 130. The design drawing information 130 is information for managing a component, an arrangement drawing, and the like used for each design pattern. Specifically, the design drawing information 130 includes a record in which a design pattern ID 131, a drawing ID 132, a component ID 133, and an arrangement quantity 134 are associated with one another.

The design pattern ID 131 is information for identifying a design pattern applied to a constituent element, such as a unit, constituting a product, and is information that is common to the design pattern ID 123 of the design pattern information 120. The drawing ID 132 is information for identifying an arrangement drawing where a component used for the associated design pattern is described. The component ID 133 is information for identifying the component. The arrangement quantity 134 is information for indicating a quantity of the component used for the associated design pattern.

For example, a record d of FIG. 5 indicates that the drawing ID of the arrangement drawing for the design pattern ID “DP10-1” is “D101”, and the arrangement quantity of the component ID “P001” is described in the drawing as “5 (pieces)”.

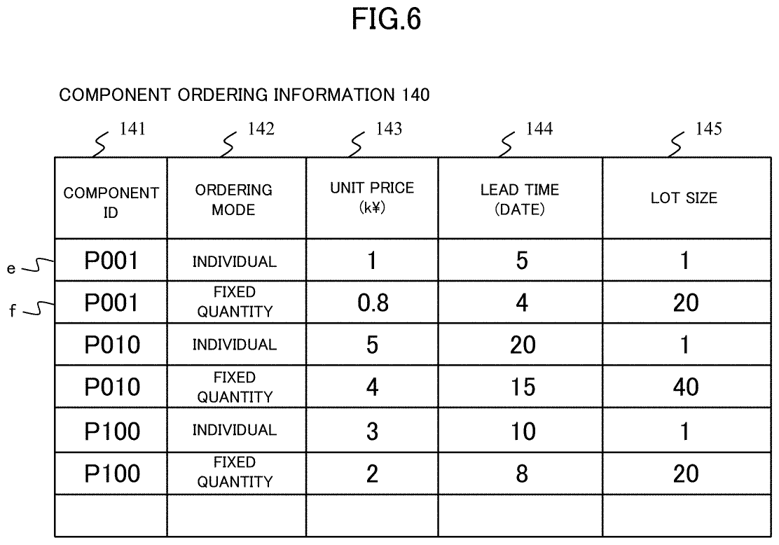

FIG. 6 is a diagram illustrating an example of the component ordering information 140. The component ordering information 140 is information for managing an ordering rule of each component, or the like. Specifically, the component ordering information 140 includes a record in which a component ID 141, an ordering mode 142, a unit price 143, a lead time 144, and a lot size 145 are associated with one another.

The component ID 141 is information for identifying a component, and is information that is common to the component ID 133 of the design drawing information 130. The ordering mode 142 is information for indicating an ordering mode, and examples thereof includes “individual”, “fixed quantity”, and “fixed period”. Note that “individual” is ordering in a small lot size depending on an individual design and component arrangement. “Fixed quantity” is ordering with a fixed quantity when an inventory quantity decreases to a predetermined level. “Fixed period” is ordering at each ordering interval set to a certain period. The unit price 143 is information for indicating a unit price of a component identified with the component ID. The lead time 144 is information for indicating a lead time from ordering to arrival. The lot size 145 is information for indicating an ordering quantity of the smallest unit to order by one order.

For example, a record e of FIG. 6 indicates that, in a case of ordering a component of the component ID “P001” in individual ordering, the unit price is “1 (k¥=thousand yen)”, the lead time is “5 (days)”, and the lot size is “1 (piece)” or more. A record f indicates that, in a case of ordering the component of the component ID “P001” in fixed-quantity ordering, the unit price is “0.8 (k¥)”, the lead time is “4 (days)”, and the lot size is “20 (pieces)” or more.

Referring back to FIG. 1, description will be continued. The communication unit 50 is a function unit performing information communication with a predetermined external device. For example, the communication unit 50 acquires information corresponding to the input information 61 from the external device, and then outputs the information to the information acquisition unit 20. For example, the communication unit 50 acquires a transmission request of predetermined information such as the output information 62 from the external device, and then transmits corresponding predetermined information to the external device.

One example of the function configuration of the component ordering mode selection device 1 has been described above.

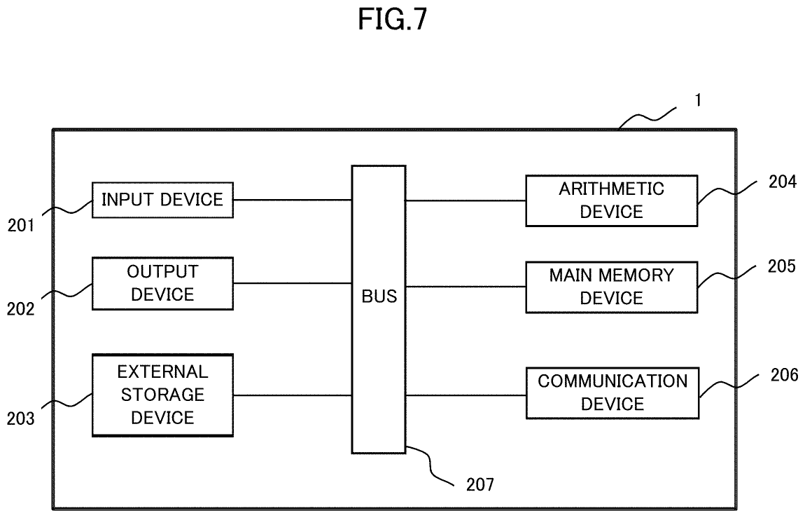

FIG. 7 is a diagram illustrating an example of a hardware configuration of the component ordering mode selection device 1. For example, the component ordering mode selection device 1 is implemented by an information processing device such as a personal computer, a work station, and a server device.

As illustrated in the drawing, the component ordering mode selection device 1 includes an input device 201, an output device 202, an external storage device 203, an arithmetic device 204, a main memory device 205, a communication device 206, and a bus 207 electrically interconnecting these devices.

The input device 201 is, for example, a key-board, a pointing device such as a mouse and a touch panel, or a microphone which is a voice input device. The output device 202 is, for example, a display, a printer, or a loudspeaker which is a voice output device.

The external storage device 203 is a nonvolatile storage device such as so-called a Hard Disk Drive, a Solid State Drive (SSD), and a flash memory which can store digital information.

For example, the arithmetic device 204 is a Central Processing Unit (CPU). The main memory device 205 is a memory device such as a Random Access Memory (RAM) or a Read Only Memory (ROM). The communication device 206 is a communication module or the like for performing information communication with an external device.

Note that the input reception unit 10, the information acquisition unit 20, the output processing unit 30, and the arithmetic unit 40 are, for example, implemented with a program to cause the arithmetic device 204 to perform processing. This program is stored in the main memory device 205 or the external storage device 203, is loaded on the main memory device 205 when performing the program, and is performed by the arithmetic device 204. The memory unit 60 is implemented by the main memory device 205 or the external storage device 203 or a combination of the main memory device 205 and the external storage device 203. The communication unit 50 is implemented by the communication device 206.

Some or all the configuration, functions, processing units, processing means, and the like described above may be implemented by hardware, for example by designing those as an integrated circuit. The above-described configuration and functions may be implemented by software, and in this case, a processor interprets and performs programs implementing respective functions. Information such as programs, tables, and files for implementing respective functions can be held in a memory device such as a memory, a Hard Disk Drive, and an SSD or a recording medium such as an IC card, an SD card, and a DVD.

[Description of Operation] The Component Ordering Mode Selection Processing Will Now be Described.

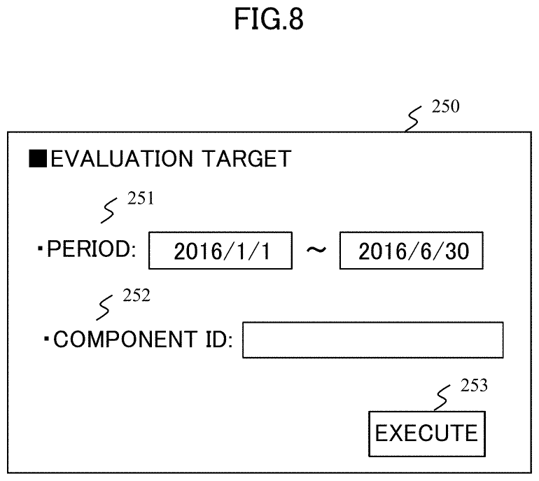

FIG. 8 is a diagram illustrating an example of an instruction input screen 250 to accept an instruction of executing the component ordering mode selection processing. As illustrated in the drawing, the instruction input screen 250 includes display of an entry field 251 for inputting a target period of processing, an entry field 252 for inputting a component ID, and a execute button 253 for instructing execution of processing. The output processing unit 30 accepts a request for display of the instruction input screen 250 through the input reception unit 10 from a user, and then generates screen information for such display, and displays the screen information on the output device 202 or the like of the component ordering mode selection device 1. The input reception unit 10 accepts at least one input of a target period or a component ID and an execution instruction of processing by pressing the execute button 253, and then starts the component ordering mode selection processing.

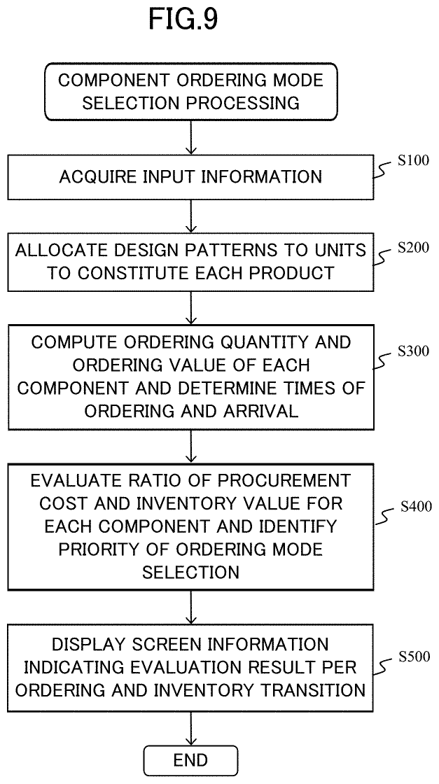

FIG. 9 is a flowchart illustrating an example of the component ordering mode selection processing. When processing is started, the information acquisition unit 20 acquires the input information 61 from the memory unit 60 (step S100). Specifically, the information acquisition unit 20 acquires the manufacturing plan information 100, the product configuration information 110, the design pattern information 120, the design drawing information 130, and the component ordering information 140. Note that the information acquisition unit 20 may not necessarily acquire the input information 61 from the memory unit 60, but, for example, may acquire the input information 61 from an external device connected through the communication unit.

Then, the product design allocation unit 41 allocates design patterns to units constituting each product, based on the future manufacturing plan (step S200). Specifically, the product design allocation unit 41 identifies, in the manufacturing plan information 100, the accepted order ID, the product model ID, the accepted order quantity, and the completion date of a record in which “procurement” is associated with the process name 104.

For example, in a case of using the manufacturing plan information 100 of FIG. 2, the product design allocation unit 41 identifies the accepted order IDs “SO01”, “SO02”, “SO03”, “SO04”, and “SO05”, the product model ID “PM01” associated with each accepted order ID, the accepted order quantity “2 (units)” associated with each accepted order ID and product model ID, and completion dates “Jan. 30, 2016”, “Mar. 1, 2016”, “Apr. 1, 2016”, “May 1, 2016”, and “Jun. 1, 2016 ”.

Then, the product design allocation unit 41 identifies the product configuration ID associated with the identified product model ID from the product configuration information 110.

For example, in a case of using the product configuration information 110 of FIG. 3, the product design allocation unit 41 identifies the product configuration IDs “PC10”, “PC11”, and “PC12” associated with the product model ID “PM01”.

Then, the product design allocation unit 41 identifies the design pattern ID and the application rate associated with the identified product configuration ID from the design pattern information 120.

For example, in a case of identifying the design pattern ID and the application rate of the product configuration ID “PC10” by using the design pattern information 120 of FIG. 4, the product design allocation unit 41 identifies the design pattern IDs “DP10-1” and “DP10-2” associated with the product configuration ID “PC10”, and the application rates “60%” and “40%” associated with the design pattern IDs, respectively.

Then, the product design allocation unit 41 generates the product design allocation information 150 in which the design pattern ID is allocated to the product configuration ID, based on the identified application rate.

Specifically, the product design allocation unit 41 randomly allocates the design pattern IDs “DP10-1” and “DP10-2” to the accepted order IDs “SO01” to “SO05”, which are order cases of the product model ID “PM01” including the product configuration ID “PC10”, so that the application rates are “60%” and “40%”. The product design allocation unit 41 associates the identified accepted-order quantities and the identified completion dates as procurement deadlines with each accepted order ID to generate the product design allocation information 150. In other words, in the product design allocation information 150, one design pattern ID is associated with each product configuration ID of each order case.

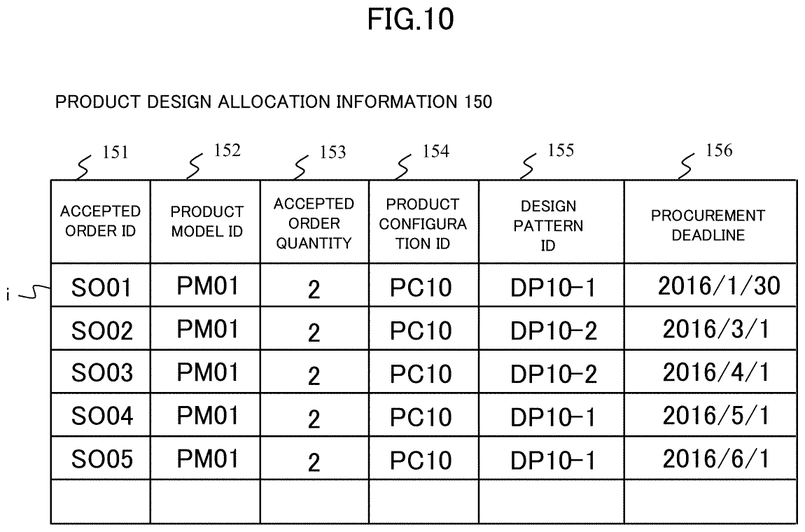

FIG. 10 is a diagram illustrating an example of the product design allocation information 150. The product design allocation information 150 is information for managing a design of an ordered product. Specifically, the product design allocation information 150 includes a record in which an accepted order ID 151, a product model ID 152, an accepted order quantity 153, a product configuration ID 154, a design pattern ID 155, and a procurement deadline 156 are associated with one another.

The accepted order ID 151 is information for identifying each of accepted orders, and is information that is common to the accepted order ID 101 of the manufacturing plan information 100. The product model ID 152 is information for identifying a model of the ordered product, and is information that is common to the product model ID 102 of the manufacturing plan information 100. The accepted order quantity 153 is information for indicating a manufacturing quantity of the ordered product, and is information that is common to the accepted order quantity 103 of the manufacturing plan information 100. The product configuration ID 154 is information for identifying a constituent element, such as a unit, constituting a product, and is information that is common to the product configuration ID 112 of the product configuration information 110. The design pattern ID 155 is information for identifying a design pattern applied to the constituent element, such as the unit, constituting the product, and is information that is common to the design pattern ID 123 of the design pattern information 120. The procurement deadline 156 is information for indicating a procurement deadline of a component identified by the design pattern ID, and is information corresponding to the completion date 106 of the manufacturing plan information 100 in which “procurement” is associated with the process name.

For example, a record i of FIG. 10 indicates that the accepted order ID is “SO01”, an order of a product of the product model ID “PM01” for “2 (units)” is received, the design pattern ID “DP10-1” is applied to the unit of the product configuration ID “PC10”, and a component used for the design pattern is procured by “Jan. 30, 2016”.

Referring back to FIG. 9, description will be continued. The component configuration identification unit 42 then computes an ordering quantity and an ordering value of each component, and the component ordering time determination unit 43 determines the times of ordering and arrival (step S300). Specifically, the component configuration identification unit 42 identifies the component ID and the arrangement quantity associated with the design pattern ID of the product design allocation information 150 from the design drawing information 130. The component configuration identification unit 42 identifies the accepted order quantity of each accepted order case and the design pattern ID associated with the accepted order quantity from the product design allocation information 150. The component configuration identification unit 42 multiplies the identified accepted order quantity by the arrangement quantity of the component for each design pattern ID, to compute an ordering quantity of the component to be used for each design pattern.

For example, in a case of computing the ordering quantity of the component for the accepted order ID “SO01” of the product design allocation information 150 illustrated in FIG. 10, the component configuration identification unit 42 identifies the component ID “P001” and the arrangement quantity “5” associated with the design pattern ID “DP10-1” associated with the accepted order ID from the design drawing information 130. The component configuration identification unit 42 identifies the accepted order quantity “2 (units)” and the design pattern ID “DP10-1” associated with the accepted order ID “SO01”. The component configuration identification unit 42 multiplies the accepted order quantity “2 (units)” by the arrangement quantity “5 (pieces)” to compute the ordering quantity of the component to be used for the design pattern as 10 (pieces).

The component configuration identification unit 42 computes an ordering value of a component. Specifically, the component configuration identification unit 42 identifies a unit price in a record associated with the component ID of the component of which the ordering quantity is computed and including the ordering mode is “individual”, from the component ordering information 140. The component configuration identification unit 42 multiplies the computed ordering quantity by the identified unit price to compute the ordering value.

For example, in a case of computing the ordering value for the component of the component ID “P001” where the ordering quantity is “10 (pieces)”, the component configuration identification unit 42 identifies the unit price “1 (k¥)” of the record associated with the component ID and including the ordering mode “individual” from the component ordering information 140. The component configuration identification unit 42 multiplies the ordering quantity “10 (pieces)” by the unit price “1 (k¥)” to compute the ordering value “10 (k¥)”.

Then, the component ordering time determination unit 43 determines the times of ordering and arrival. Specifically, the component ordering time determination unit 43 identifies a lead time in a record associated with the component ID for which the ordering quantity is computed and including the ordering mode “individual”, from the component ordering information 140. The component ordering time determination unit 43 identifies the procurement deadline of the component of the component ID from the product design allocation information 150, and determines the date obtained by subtracting the lead time from the procurement deadline as the ordering date. The component ordering time determination unit 43 determines the date of the procurement deadline as the arrival date.

Note that examples of the ordering mode include “fixed quantity” and “fixed period” other than above-mentioned “individual”. In a case of determining an ordering quantity, an ordering value, an ordering date, an arrival date, and the like in the ordering mode “fixed quantity” or “fixed period”, the component configuration identification unit 42 and the component ordering time determination unit 43 may use, for example, a predetermined method such as Material Requirement Planning (MRP).

The component ordering time determination unit 43 gives an order ID for each component ID, and generates the component ordering time determination information 160 in which an ordering mode and an ordering quantity, an ordering value, an ordering date, and an arrival date are associated with one another.

For example, in a case of determining an ordering time and an arrival time of a component for the accepted order ID “SO01” in the product design allocation information 150 illustrated in FIG. 10, the component ordering time determination unit 43 identifies the lead time “5 (days)” in a record associated with the component ID “P001” for which the ordering quantity is computed and including the ordering mode “individual”, from the component ordering information 140. The component ordering time determination unit 43 identifies the procurement deadline “Jan. 30, 2016” of the component of the component ID from the product design allocation information 150, and determines the date “Jan. 25, 2016” obtained by subtracting “5 (days)” from the procurement deadline as the ordering date. The component ordering time determination unit 43 determines “Jan. 30, 2016”, which is the procurement deadline, as the arrival date. The component ordering time determination unit 43 generates the component ordering time determination information 160 where a predetermined order ID is associated with the component ID “P001”, and the ordering mode (“individual” in this case), the ordering quantity “10 (pieces)”, the ordering value “10 (k¥)”, the ordering date “Jan. 25, 2016,” and the arrival date “Jan. 30, 2016” are associated with one another.

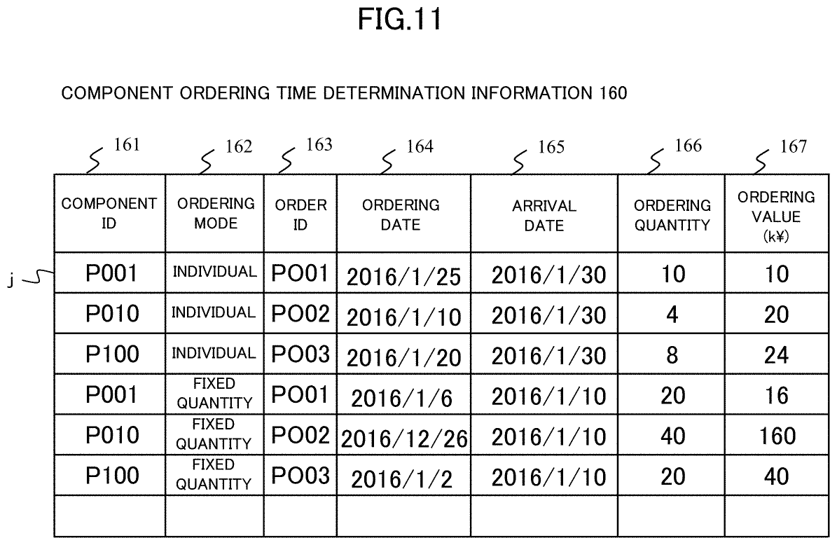

FIG. 11 is a diagram illustrating an example of the component ordering time determination information 160. The component ordering time determination information 160 is information for managing an ordering quantity and an ordering time of each component. Specifically, the component ordering time determination information 160 includes a record in which a component ID 161, an ordering mode 162, an order ID 163, an ordering date 164, an arrival date 165, an ordering quantity 166, and an ordering value 167 are associated with one another.

The component ID 161 is information for identifying a component, and is information that is common to the component ID 133 of the design drawing information 130. The ordering mode 162 is information for indicating an ordering mode of a component, and is information that is common to the ordering mode 142 of the component ordering information 140. The order ID 163 is information for identifying an order of a component, and an ID that is common for each component ID is used. The ordering date 164 is information for indicating an ordering date of a component. The arrival date 165 is information for indicating an arrival date of a component. The ordering quantity 166 is information for indicating an ordering quantity of a component. The ordering value 167 is information for indicating an ordering value of a component.

For example, a record j of FIG. 11 illustrates an order of the accepted order ID “PO01”, which places an order for “10 (pieces)” components of the component ID “P001” in an ordering mode of “individual” on “Jan. 25, 2016”, with the ordering value “10 (k¥)”, and arrives on “Jan. 30, 2016”.

Referring back to FIG. 9, description will be continued. The ordering mode evaluation unit 46 then evaluates a ratio of a procurement cost and an inventory value for each component, and identifies priority of ordering mode selection (step S400). For the evaluation, the procurement cost computation unit 44 generates the procurement cost transition information 170. Specifically, the procurement cost computation unit 44 extracts the component ID, the ordering mode, the order ID, the arrival date, the ordering quantity, and the ordering value from the component ordering time determination information 160, and generates the procurement cost transition information 170 in which these are associated with one another.

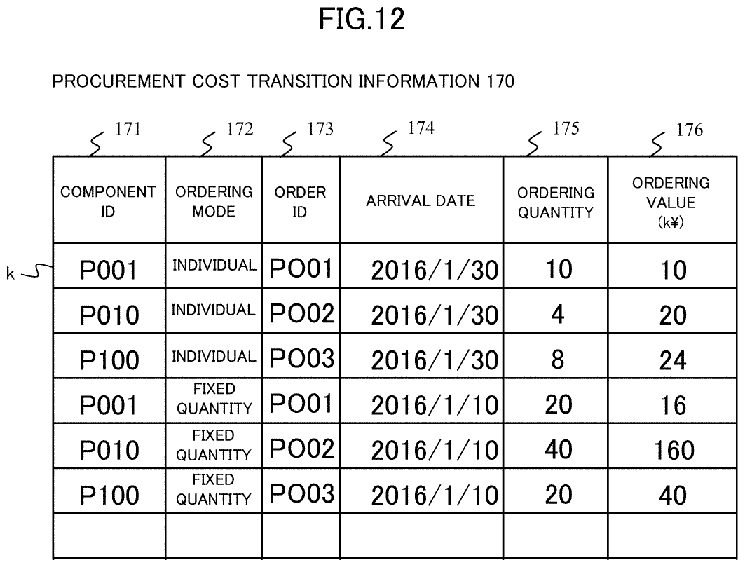

FIG. 12 is a diagram illustrating an example of the procurement cost transition information 170. The procurement cost transition information 170 is information for indicating a transition of the procurement cost caused based on the arrival date of the component. Specifically, the procurement cost transition information 170 includes a record in which a component ID 171, an ordering mode 172, an order ID 173, an arrival date 174, an ordering quantity 175, and an ordering value 176 are associated with one another.

The component ID 171 is information for identifying a component, and is information that is common to the component ID 133 of the design drawing information 130. The ordering mode 172 is information for indicating an ordering mode of a component, and is information that is common to the ordering mode 142 of the component ordering information 140. The ordering ID 173 is information for identifying an order of a component, and an ID that is common for each component ID is used. The arrival date 174 is information for indicating an arrival date of a component. The ordering quantity 175 is information for indicating an ordering quantity of a component. The ordering value 176 is information for indicating an ordering value of a component.

For example, a record k of FIG. 12 illustrates an order of the order ID “PO01”, which places an order for “10 (pieces)” components of the component ID “P001” in an ordering mode of “individual”, with the ordering value “10 (k¥)”, and arrives on “Jan. 30, 2016”.

For the evaluation above, the inventory value computation unit 45 generates the component inventory transition information 180. Specifically, the inventory value computation unit 45 identifies the design pattern ID for each product configuration ID from records of the product design allocation information 150, each of the records being associated with the accepted order ID and the product model ID of the record of the manufacturing plan information 100 including the process name of “procurement”. The inventory value computation unit 45 identifies the component ID associated with the design pattern ID from the design drawing information 130. The inventory value computation unit 45 identifies the unit price associated with the identified component ID from the component ordering information 140 per ordering mode. The inventory value computation unit 45 identifies the ordering mode, the arrival date, and the ordering quantity from the record associated with the identified component ID by using the component ordering time determination information 160.

The inventory value computation unit 45 generates the component inventory transition information 180 in which the identified component ID, the ordering mode, an arrival or shipment category (in this case, arrival), an arrival or shipment date (in this case, the date of the identified arrival date), an arrival or shipment quantity (in this case, the identified ordering quantity), an inventory quantity (a quantity obtained by adding the identified ordering quantity to the former inventory quantity), and the inventory value (a value obtained by multiplying the unit price in the corresponding ordering mode by the inventory quantity) are associated with one another.

The inventory value computation unit 45 identifies the accepted order quantity and the completion date of the record of the manufacturing plan information 100, the record including the process name of “shipment”. The inventory value computation unit 45 identifies the design pattern ID for each product configuration ID from the record of the product design allocation information 150, the record being associated with the accepted order ID and the product model ID of the identified record described above. The inventory value computation unit 45 identifies the component ID and the arrangement quantity of the record associated with the design pattern ID from the design drawing information 130. The inventory value computation unit 45 identifies the unit price associated with the identified component ID from the component ordering information 140 per ordering mode.

The inventory value computation unit 45 generates a record for the component inventory transition information 180 in which the identified component ID, the ordering mode, the arrival or shipment category (in this case, shipment), the arrival or shipment date (in this case, the date of the identified completion date), the arrival or shipment quantity (in this case, a quantity of the shipment obtained by multiplying the identified accepted order quantity by the arrangement quantity), the inventory quantity (a quantity obtained by subtracting the quantity of the shipment from the former inventory quantity), and the inventory value (a value obtained by multiplying the unit price in the corresponding ordering mode by the inventory quantity) are associated with one another.

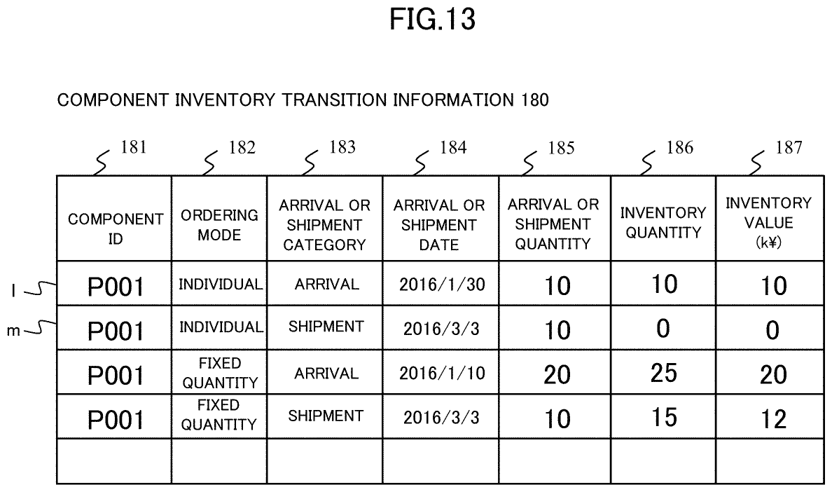

FIG. 13 is a diagram illustrating an example of the component inventory transition information 180. The component inventory transition information 180 is information for indicating transition of a component inventory. As described above, the component inventory transition information 180 includes a record in which a component ID 181, an ordering mode 182, an arrival or shipment category 183, an arrival or shipment date 184, an arrival or shipment quantity 185, an inventory quantity 186, and an inventory value 187 are associated with one another.

The component ID 181 is information for identifying a component, and is information that is common to the component ID 133 of the design drawing information 130. The ordering mode 182 is information for indicating an ordering mode of a component, and is information that is common to the ordering mode 142 of the component ordering information 140. The arrival or shipment category 183 is information for indicating arrival or shipment of a component. The arrival or shipment date 184 is information for indicating a date of arrival or shipment of a component. The arrival or shipment quantity 185 is information for indicating either an arrival quantity or a shipment quantity of a component. The inventory quantity 186 is information for indicating an inventory quantity. The inventory value 187 is information for indicating a value obtained by multiplying an inventory quantity by a unit price of an inventory component in a corresponding ordering mode, in other words, a total unit price of an inventory component.

For example, a record 1 of FIG. 13 is a record for indicating the category of “arrival”, which indicates that “10 (pieces)” components of the component ID “P001” ordered in the ordering mode of “individual” arrive on “Jan. 30, 2016”, then the inventory quantity becomes “10 (pieces)”, and the inventory value is “10 (k¥)”.

A record m of FIG. 13 is a record for indicating the category of “shipment”, which indicates that the shipment date of the product manufactured using “10 (pieces)” components of the component ID “P001” ordered in the ordering mode of “individual” is “Mar. 3, 2016”, and the inventory quantity and the inventory value become “0 (piece)” and “0 (k¥)” on the shipment date.

The ordering mode evaluation unit 46 evaluates a relation between the procurement cost and the inventory value for each component. For the evaluation, the procurement cost computation unit 44 computes the procurement cost by using the procurement cost transition information 170. The inventory value computation unit 45 computes the inventory value by using the component inventory transition information 180. The computation of the procurement cost and the inventory value will be described later.

The ordering mode evaluation unit 46 computes an evaluation coefficient of evaluating the relation between the procurement cost and the inventory value for each component by using following Equation (1).

$$\begin{matrix}[ Equation 1 ] & \\ {E}_{j} = \frac{{C}_{ja} - {C}_{jb}}{{I}_{jb} - {I}_{ja}} & Equation ( 1 )\end{matrix}$$

In Equation (1), a subscript j denotes a component ID. Cⱼₐ denotes a procurement cost obtained by adding an ordering value in the ordering mode of “individual” and an ordering value in the ordering mode of “fixed quantity”. C_{jb} denotes a procurement cost obtained by adding the ordering value in the ordering mode of “fixed quantity” and an ordering value when switching the ordering mode of “individual” to the ordering mode of “fixed quantity”. Iⱼₐ denotes an inventory value obtained by adding an inventory value in the ordering mode of “individual” and an inventory value in the ordering mode of “fixed quantity”. I_{jb} denotes an inventory value obtained by adding an inventory value in the ordering mode of “fixed quantity” and the inventory value when switching the ordering mode of “individual” to the ordering mode of “fixed quantity”. Eⱼ denotes an evaluation coefficient. A computation method of Cⱼₐ, C_{jb} , Iⱼₐ, and I_{jb} will be described below.

The procurement cost computation unit 44 computes the procurement cost Cⱼₐ by adding the ordering value in the ordering mode of “individual” of the procurement cost transition information 170 and the ordering value in the ordering mode of “fixed quantity”. For example, in a case of using the procurement cost transition information 170 of FIG. 12, the procurement cost Cⱼₐ of the component ID “P001” is computed as the value “26 (k¥)” by adding the ordering value “10 (k¥)” in the ordering mode of “individual” and the ordering value “16 (k¥)” with the ordering mode of “fixed quantity”. Note that when there are multiple orderings in each of the ordering modes of “individual” and “fixed quantity”, adding up ordering values for these orderings can compute Cⱼₐ.

The procurement cost computation unit 44 computes the procurement cost C_{jb} by adding the ordering value computed by multiplying the unit price in the ordering mode of “fixed quantity” by the smallest lot size when the ordering quantity associated with the ordering mode of “individual” is placed an order in the ordering mode of “fixed quantity”, and the ordering value in the ordering mode of “fixed quantity” of the procurement cost transition information 170. For example, in a case of using the procurement cost transition information 170 of FIG. 12, the procurement cost C_{jb} for the component of the component ID “P001” is “24 (k¥)” by adding the ordering value “8 (k¥)” computed by multiplying the unit price “0.8 (k¥)” in the ordering mode of “fixed quantity” by the smallest lot size “20 (pieces)” when the ordering quantity “10 (pieces)” associated with the ordering mode of “individual” is placed an order in the ordering mode of “fixed quantity”, and the ordering value “16 (k¥)” in the ordering mode of “fixed quantity” of the procurement cost transition information 170. Note that, for example, when there are multiple orders in each of the ordering modes of “individual” and “fixed quantity”, converting the ordering values in the ordering mode of “individual” to ordering values in the ordering mode of “fixed quantity” similarly to the above and adding up these ordering values can compute C_{jb}.

The inventory value computation unit 45 computes the inventory value Iⱼₐ by adding a period average of the inventory values in the ordering mode of “individual” and a period average of the inventory values in the ordering mode of “fixed quantity”, in the component inventory transition information 180. For example, in a case of computing the period average of the inventory values per month, adding up the inventory values in the last day of the month (or the first day of the month) for each month per component and per ordering mode and dividing the adding result by the number of months can compute the period average of the inventory values per component and per ordering mode. In a case of computing the period average of the inventory values per day, adding up the inventory value at the time of arrival and the inventory value at the time of shipment per component and per ordering mode and dividing the adding result by the number of days of arrival and shipment can compute the period average of the inventory values per component and per ordering mode.

The inventory value computation unit 45 computes the inventory value I_{jb} by adding the period average of the inventory values in the ordering mode of “fixed quantity”, and the period average when converting the period average of the inventory values associated with the ordering mode of “individual” to the inventory values in the ordering mode of “fixed quantity”, in the component inventory transition information 180. Note that although a component unit price in the ordering mode of “fixed quantity” is lower in comparison with a component unit price in the ordering mode of “individual”, I_{jb} is usually greater than Iⱼₐ because the smallest lot size increases.

The ordering mode evaluation unit 46 computes the evaluation coefficient Eⱼ by applying the procurement costs Cⱼₐ and C_{jb} and the inventory values Iⱼₐ and I_{jb} computed in this way, to Equation (1). With the use of this, a ratio of a reduction effect of a procurement cost and an increment of an inventory value when switching an ordering mode from “individual” to “fixed quantity” can be evaluated. Specifically, a greater value of Eⱼ indicates a higher reduction effect of the procurement cost against an increase of the inventory value and higher priority for switching of an ordering mode.

The ordering mode evaluation unit 46 generates the evaluation information per ordering 190 including an evaluation result for each component.

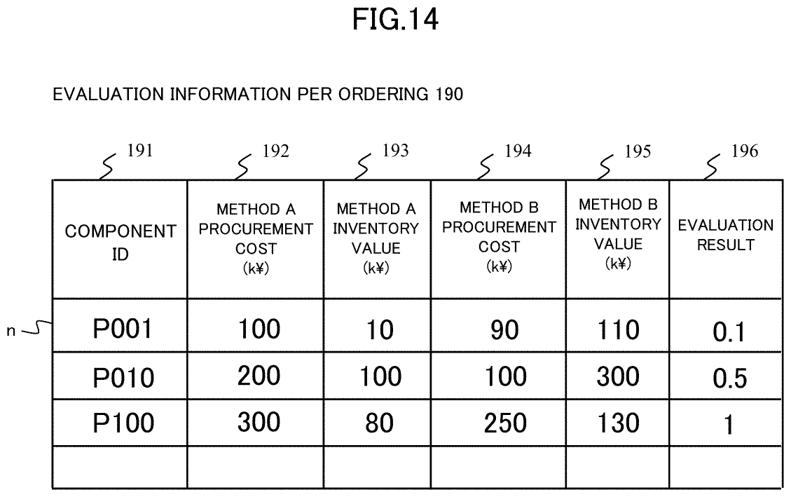

FIG. 14 is a diagram illustrating an example of the evaluation information per ordering 190. The evaluation information per ordering 190 is information including the evaluation result of each component. Specifically, the evaluation information per ordering 190 includes a record in which a component ID 191, a method A procurement cost 192, a method A inventory value 193, a method B procurement cost 194, a method B inventory value 195, and an evaluation result 196 are associated with one another.

The component ID 191 is information for identifying a component, and is information that is common to the component ID 133 of the design drawing information 130. The method A procurement cost 192 is information for indicating a sum (in other words, Cⱼₐ) of ordering values in the ordering modes of “individual” and “fixed quantity”. The method A inventory value 193 is information for indicating a sum (in other words, Iⱼₐ) of inventory values with the ordering modes of “individual” and “fixed quantity”. The method B procurement cost 194 is information for indicating a sum (in other words, C_{jb}) of an ordering value in the ordering mode of “fixed quantity” and an ordering value when switching the ordering mode of “individual” to the ordering mode of “fixed quantity”. The method B inventory value 195 is information for indicating a sum (in other words, I_{jb}) of an inventory value in the ordering mode of “fixed quantity” and an inventory value when switching the ordering mode of “individual” to the ordering mode of “fixed quantity”. The evaluation result 196 is information for indicating an evaluation coefficient (in other words, Eⱼ) obtained through evaluation of a relation between a procurement cost and an inventory value.

For example, a record n of FIG. 14 indicates that, for the component of the component ID “P001”, sums of the ordering value and the inventory value in the ordering mode of “individual” and “fixed quantity” are “100 (k¥)” and “10 (k¥)”, respectively, sums of the ordering value and the inventory value when switching the ordering mode of “individual” to the ordering mode of “fixed quantity” are “90 (k¥)” and “110 (k¥)”, respectively, and the evaluation coefficient is “0.1”.

Referring back to FIG. 9, description will be continued. The output processing unit 30 generates screen information indicating the evaluation result per ordering and the inventory transition by using the evaluation information per ordering 190. The output processing unit 30 displays the generated screen information on the output device 202 or the like (step S500).

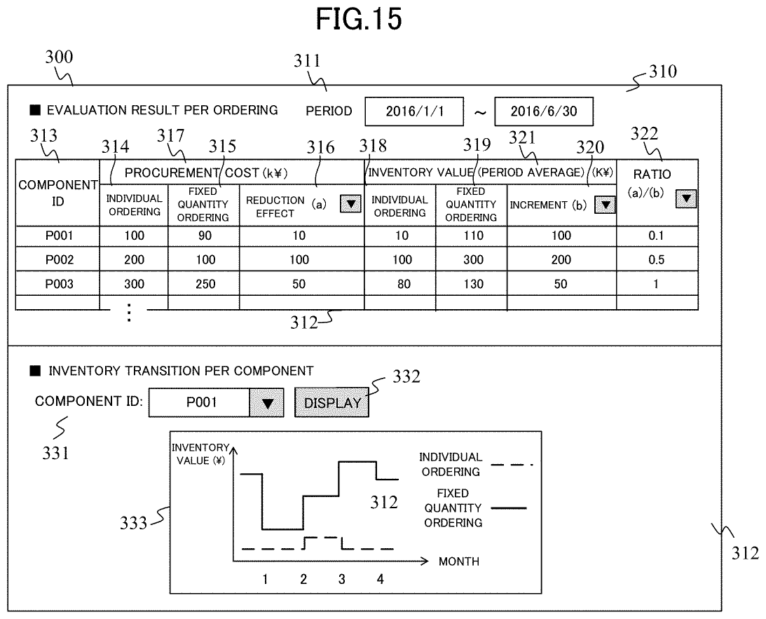

FIG. 15 is a screen example 300 illustrating the evaluation result per ordering and the inventory transition per component. The screen example 300 includes an evaluation result display area 310 and an inventory transition display area 330. The evaluation result display area 310 includes a period 311 for indicating a target period for an evaluation and a result display table 312 for indicating the evaluation result. The period is a target period of the evaluation accepted through the input screen of FIG. 8. The result display table 312 includes a record in which a component ID 313, a procurement cost 317 including an individual ordering 314, a fixed-quantity ordering 315 and a reduction effect 316, a period average of an inventory value 321 including an individual ordering 318, a fixed-quantity ordering 319 and an increment 320, and a ratio 322 are associated with one another.

The component ID 313 is information for identifying a component, and is information that is common to the component ID 133 of the design drawing information 130. The individual ordering 314 of the procurement cost is information for indicating a sum (in other words, Cⱼₐ) of an ordering value in the ordering mode of “individual” and an ordering value in the ordering mode of “fixed quantity”. The fixed-quantity ordering 315 of the procurement cost is information for indicating a sum (in other words, C_{jb}) of an ordering value in the ordering mode of “fixed quantity” and an ordering value when switching the ordering mode of “individual” to the ordering mode of “fixed quantity”. The reduction effect 316 is a value obtained by subtracting the fixed-quantity ordering from the individual ordering, in the procurement cost, and is information for indicating the reduction effect of the procurement cost when switching the ordering mode from “individual” to “fixed quantity”.

The individual ordering 318 of the inventory value is information for indicating a sum (in other words, Iⱼₐ) of an inventory value with the ordering mode of “individual” and an inventory value with the ordering mode of “fixed quantity”. The fixed-quantity ordering 319 of the inventory value is information for indicating a sum (in other words, I_{jb}) of an inventory value with the ordering mode of “fixed quantity” and an inventory value when switching the ordering mode of “individual” to the ordering mode of “fixed quantity”. The ratio 322 is information for indicating an evaluation coefficient (in other words, Eⱼ) of evaluating a relation between a procurement cost and an inventory value for each component.

Note that each of the reduction effect 316 of the procurement cost, the increment 320 of the inventory value, and the ratio 322 can be filtered or sorted via a display of a pull-down menu in response to pressing of a pull-down box. With this operation, for example, a component which is not expected the reduction effect of the procurement cost equal to or larger than a certain value, a component where an inventory increment exceeds a certain value, and a component where the reduction effect of the procurement cost against the increment of the inventory value is small can be excluded from display, or components can be sorted in descending order of the reduction effect.

The inventory transition display area 330 includes a component ID 331, a display button 332, and an inventory transition graph 333. Pressing a pull-down box of the component ID 331 to display a pull-down menu, and selecting a certain component ID and then pressing the display button 332 causes the inventory transition graph 333 of the component to be displayed. In the inventory transition graph 333, the vertical axis represents the inventory value, and the horizontal axis represents the month. A graph of a dashed line represents the sum (in other words, Iⱼₐ) of the inventory value in the ordering mode of “individual” and the inventory value in the ordering mode of “fixed quantity”. A solid line represents the sum (in other words, I_{jb}) of the inventory value in the ordering mode of “fixed quantity” and the inventory value when switching the ordering mode of “individual” to the ordering mode of “fixed quantity”. Thus, the inventory transition graph visualizes the inventory transition per component ID in time series for each ordering mode. Thereby, the inventory peak time or the like in a case of switching the ordering mode can be managed in forestalling management.

The component ordering mode selection device 1 according to the present embodiment has been described above. The component ordering mode selection device 1 can, on the basis of a future manufacturing plan, facilitate an evaluation of a relation between a procurement cost and an inventory value of a component, and a selection of a more appropriate ordering mode.

Note that the present invention is not limited to the embodiment above, and various modifications are possible. For example, in the embodiment above, the design pattern is randomly allocated to the unit of each product depending on the predetermined application rate, but as described above, in a case that there are a design pattern applied to an old type product and a design pattern to be applied to a new type product, revision information representing an old design pattern or a new design pattern may be associated with the design drawing information 130, and the old design pattern with the revision representing the old design may be preferentially and sequentially allocated from a constituent element of a product planned to manufacture in the closest future depending on the predetermined application rate. With this operation, the relation between the procurement cost and the inventory value per component and per ordering mode can be evaluated when sequentially switching from the old design pattern with the revision representing old design to the new design pattern.

Moreover, the transition of the component inventory according to the embodiment above is based on the arrival date of the component and the shipment date of the product using the component, but the inventory value computation unit 45 may be based on a leaving date of leaving a component (initiation of manufacturing) from a warehouse instead of being based on the shipment date, and a component weight, size, and storage cost related to inventory management in a warehouse may be used as an evaluation index instead of the inventory value. In this case, for example, the component ordering information 140 may include information about a storage cost per component. With this configuration, in manufacturing an individual order design product such as a large component or a special component where an inventory management cost is generally higher, an ordering mode of a component in consideration of a management cost in a warehouse can be selected.

Note that the present invention is not limited to the examples described above, and is intended to cover various modifications. For example, the examples presented above has been described in detail to provide a clear understanding of the present invention and the present invention is not necessarily limited to embodiments including all of the configurations described above. In addition, a part of the configuration of a certain example can be replaced with a configuration of another example, and a configuration of another embodiment can be added to a configuration of a certain embodiment. Further, another configuration can be added to a part of the configuration of each example, and a part of the configuration of each example can be deleted or replaced.

The control lines and information lines illustrated are those considered necessary for purposes of description and do not necessarily represent all control lines and information lines required to the product. As a practical matter, almost all configurations may be considered to be mutually coupled.

### REFERENCE SIGNS LIST

1 Component ordering mode selection device
10 Input reception unit
20 Information acquisition unit
30 Output processing unit
40 Arithmetic unit
41 Product design allocation unit
42 Component configuration identification unit
43 Component ordering time determination unit
44 Procurement cost computation unit
45 Inventory value computation unit
46 Ordering mode evaluation unit
50 Communication unit
60 Memory unit
61 Input information
62 Output information
100 Manufacturing plan information
110 Product configuration information
120 Design pattern information
130 Design drawing information
140 Component ordering information
150 Product design allocation information
160 Component ordering time determination information
170 Procurement cost transition information
180 Component inventory transition information
190 Evaluation information per ordering
201 Input device
202 Output device
203 External storage device
204 Arithmetic device
205 Main memory device
206 Communication device

What is claimed is:

1. A component ordering mode selection device comprising:
a product design allocation unit configured to allocate a predetermined design pattern to a product constituent element at a predetermined application rate which is based on a future design plan;
a procurement cost computation unit configured to compute, for each ordering mode, a procurement cost of a component which is used in the product constituent element;
an inventory value computation unit configured to compute, for each ordering mode, an inventory value of the component; and
an ordering mode evaluation unit configured to evaluate a ratio of the procurement cost and the inventory value.

2. The component ordering mode selection device according to claim 1, wherein
the design pattern includes a first design pattern applied to the product constituent element of an old type product, and a second design pattern to be applied to the product constituent element of a new type product, and
the product design allocation unit
allocates the first design pattern and the second design pattern to the product constituent element at the predetermined application rate which is based on the future manufacturing plan.

3. The component ordering mode selection device according to claim 2, wherein
the ordering mode evaluation unit
computes a ratio of a reduction amount of a procurement cost and an increment amount of an inventory value when an ordering mode is switched from an individual ordering to a fixed-quantity ordering.

4. The component ordering mode selection device according to claim 3, wherein
the procurement cost computation unit
computes the reduction amount of the procurement cost by subtracting a procurement cost obtained by adding an ordering value in the fixed-quantity ordering and an ordering value when the ordering mode is switched from the individual ordering to the fixed-quantity ordering, from a procurement cost obtained by adding an ordering value in the individual ordering and the ordering value in the fixed-quantity ordering.

5. The component ordering mode selection device according to 3, wherein
the inventory value computation unit
computes the increment amount of the inventory value by subtracting an inventory value obtained by adding an inventory value in the individual ordering and an inventory value in the fixed-quantity ordering, from an inventory value obtained by adding the inventory value in the fixed-quantity ordering and an inventory value when the ordering mode is switched from the individual ordering to the fixed-quantity ordering.

6. The component ordering mode selection device according to claim 2, wherein
the design pattern includes revision information representing the old design or the new design, and
the product design allocation unit,
preferentially and sequentially allocates the first design pattern with the revision information representing the old design, from a constituent element of a product planned to manufacture in the closest future depending on the predetermined application rate.

7. The component ordering mode selection device according to claim 1, wherein
the inventory value computation unit
computes, for each ordering mode, a storage cost which costs from an arrival of a component to a shipment of the component from a warehouse, instead of the inventory value, and
the ordering mode evaluation unit
evaluates a ratio of the procurement cost and the storage cost.

8. A component ordering mode selection method performed by a component ordering mode selection device, the component ordering mode selection method comprising:
a product design allocation step for allocating a predetermined design pattern to a product constituent element at a predetermined application rate which is based on a future design plan;
a procurement cost computation step for computing, for each ordering mode, a procurement cost of a component which is used in the product constituent element;
an inventory value computation step for computing, for each ordering mode, an inventory value of the component; and
an ordering mode evaluation step for evaluating a ratio of the procurement cost and the inventory value.

9. A program causing a computer to function as a component ordering mode selection device, the program causing the computer to function as:
a product design allocation unit configured to allocate a predetermined design pattern to a product constituent element at a predetermined application rate which is based on a future design plan;
a procurement cost computation unit configured to compute, for each ordering mode, a procurement cost of a component which is used in the product constituent element;
an inventory value computation unit configured to compute, for each ordering mode, an inventory value of the component; and
an ordering mode evaluation unit configured to evaluate a ratio of the procurement cost and the inventory value.
